(19) United States
(12) Patent Application Publication
(10) Pub. No.: US 2018/0268429 A1
(43) Pub. Date: Sep. 20, 2018

(54) SYSTEM AND METHOD FOR GENERATING AN OPTIMUM PRICE FOR A COMMODITY

(71) Applicant: Myntra Designs Private Limited, Bangalore (IN)

(72) Inventors: Joshi Prasad PRADIP, Bangalore (IN); Warrier DEEPAK, Bangalore (IN)

(73) Assignee: Myntra Designs Private Limited, Bangalore (IN)

(21) Appl. No.: 15/904,593

(22) Filed: Feb. 26, 2018

(30) Foreign Application Priority Data
Mar. 20, 2017 (IN) 201741009543

(51) Int. Cl. G06Q 30/02; G06Q 10/06

(52) U.S. Cl. CPC G06Q 30/0206; G06Q 30/0202; G06Q 10/067

(57) ABSTRACT

A system for generating an optimum price for a plurality of commodities is provided. The system includes an insight module configured to enumerate a plurality of components that contribute to the pricing model. The insight module comprises of a need state discovery module, a demand learning module and a prediction module. The need state discovery module is configured to identify a subset of the one and more commodities with a plurality of features. The demand learning module is configured to generate a demand sensitivity for the subset plurality of commodities and the prediction module is configured to generate a demand forecast for the subset plurality of commodities. The system includes a simulation optimizer configured to generate a plurality of pricing models for each commodity in the subset. Each pricing model is computed based on a unique combination of price attributes. Furthermore, the system also includes a price module configured to select an optimum pricing model from the plurality of pricing models.

### PRIORITY STATEMENT

The present application hereby claims priority under 35 U.S.C. § 119 to Indian patent application number 201741009543 filed 20 Mar. 2017, the entire contents of which are hereby incorporated herein by reference.

### FIELD

Embodiments of the invention relates generally to pricing strategies and more particularly to a system and method for generating an optimum price for a commodity being sold on an e-commerce platform.

### BACKGROUND

Pricing is one of the major strategic elements of marketing and has evolved over time. Pricing directly affects the marketing mix elements such as product features, business decisions, and promotions. Utilizing an effective pricing strategy requires not only test-and-learn methods but also an intuitive feel about how brands and products would be perceived. The way pricing strategies are utilized will have a direct effect on purchasing decisions and thus on the success of any business.

Though pricing strategies can be complex, one of the basic rules of pricing is to review prices frequently to assure that they reflect the dynamics of cost, market demand, response to the competition and profit objectives. While there is no single way to determine pricing of products, retail businesses generally adhere to various pricing strategies. Such strategies could be market based (leveraging market position and guided by the pricing adopted by other firms.), value based (pricing focused on consumer need/demand based pricing.), cost plus (based on the cost of the goods plus the expected margins) or other types. Typically, retail businesses adhere to a mix of such strategies instead of following just one pricing strategy. By applying various pricing approaches, retailer businesses utilize pricing as a marketing weapon for their products.

In recent years, pricing of products and services being sold online has become one of the most exciting and complex aspects in e-commerce. E-retailers are provided an unprecedented visibility into customer purchase behavior and an environment in which prices can be updated quickly and economically in response to changing market conditions. Broad range of offerings in the form of discounts, coupons, deals etc. are being offered to attract hordes of customers. Such dynamic pricing strategies are widely used for maximizing revenue in an Internet retail channel by actively learning customers' demand response to price (price elasticity) and thus providing a rich framework for pricing projects such as portfolio optimization, simulation experiments in pricing, dynamic adaptive pricing, etc.

However, such broader level insights might not lead to correct assumptions, especially in the fashion industries. Elasticity models are generally used to understand how different styles within a category behave at different pricing levels. Categorizing products with same elasticity in one group without considering other aspects at the granular level might not always yield the correct results and due to the risk of data sparsity at granular level, various important emerging patterns might go unnoticed. Thus, with the traditional methods of pricing, these fundamental challenges and differences in the pricing for fashion e-retail still exist.

Thus, there is a need to build models at a right granular level to understand how the customers/users perceive a collection (assumed to be similar) on multitude of attributes such as brand, article, style, color and so on. In other words, the user-product interaction along with other changes in the ecosystem, needs to be understood at a much deeper level to uncover business insights and thus formulate strategies targeting the intended audience with the intended product/feature at the right optimum price. Such micro-level insights can be either used towards creating targeted campaigns or can be incorporated in complex algorithms while suggesting discounting of products. Therefore, an intelligent and data driven strategy model is required for obtaining optimum price of commodities by continuously refining the assumptions based upon data perceived at a granular level.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description. Example embodiments provide a system to generate an optimum price for a commodity.

Briefly, according to an example embodiment, a system for generating an optimum pricing model for a plurality of commodities is provided. The system includes an insight module configured to enumerate a plurality of components that contribute to the pricing model. The insight module comprises of a need state discovery module, a demand learning module and a prediction module. The need state discovery module is configured to identify a subset of the one and more commodities with a plurality of features. The demand learning module is configured to generate a demand sensitivity for the subset plurality of commodities and the prediction module is configured to generate a demand forecast for the subset plurality of commodities. Further, the system includes a simulation optimizer configured to generate a plurality of pricing models for each commodity in the subset. Each pricing model is computed based on a unique combination of price attributes. Furthermore, the system also includes a price module configured to select an optimum pricing model from the plurality of pricing models.

In another embodiment, a method for generating an optimum pricing model for a plurality of commodities is provided. The method comprises enumerating a plurality of components that contribute to the pricing model by identifying a subset of the one and more commodities a plurality of features, generating a demand sensitivity for the subset plurality of commodities and generating a demand forecast for the subset plurality of commodities. The method further includes generating a plurality of pricing models for each commodity in the subset; wherein each pricing model is computed based on a unique combination of price attribute. The method further includes selecting an optimum pricing model from the plurality of pricing models.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating a pricing engine interfaced with the retail platform, according to the aspects of the present invention

FIG. 2 is a block diagram of the pricing system to generate an optimum price for plurality of commodities, according to the aspects of the present invention;

FIG. 3 is a block diagram of the insight module, implemented according to aspects of the present technique;

FIG. 4 is a block diagram of one embodiment of the pricing engine to generate a plurality of pricing models, according to the aspects of the present technique and

FIG. 5 is a flow diagram illustrating the steps involved in generating the optimum price of one or more commodities, according to aspects of the present invention.

FIG. 6A and FIG. 6B are screenshots illustrating the comparison charts generated within the plurality of sub-categories, according to the aspects of the present invention.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled”. Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The systems described herein, may be realized by hardware elements, software elements and/or combinations thereof. For example, the devices and components illustrated in the example embodiments of inventive concepts may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

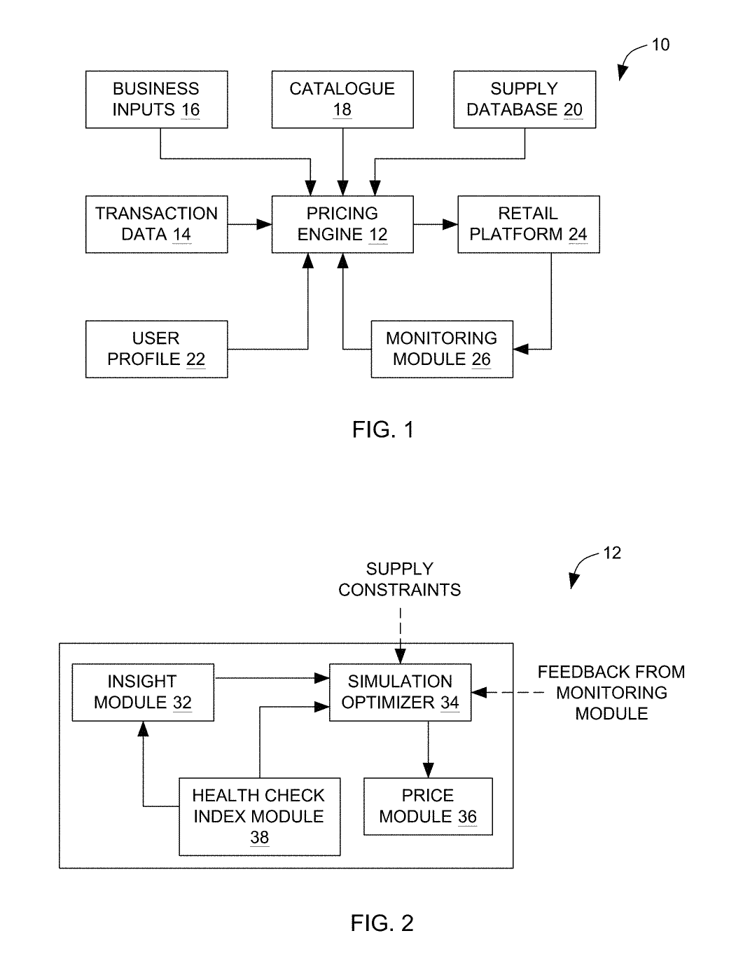

At least one example embodiment is generally directed to a system and techniques for generating an optimum price for a plurality of commodities. FIG. 1 is a block diagram of a system 10 illustrating a pricing engine interfaced with a retail platform, according to the aspects of the present invention. The pricing engine is configured to receive several inputs from different sources and accordingly generate an optimum price for one or more commodities. The manner in which the pricing engine operates is described in further detail below.

Pricing engine 12 is configured to provide an optimum price for one or more commodities to the retail platform 24. For the purpose of this description, the following embodiments are described with respect to an online fashion retail platform. However, it must be understood that embodiments described herein can be implemented on an e-commerce platform.

Pricing engine 12 is configured to receive data related to user profile 22. The user profiles usually include an age, gender, preference, etc. associated to a user visiting the retail platform. Further, the pricing engine 12 may receive input data from various elements. Such elements include transaction data 14, business inputs 16, catalogue 18, supply database 20.

Transaction data 14 may include orders, invoices, payments, activity records, plans, deliveries, storage records and the like. Business inputs 16 may include resources such as raw materials, energy, people, finance and the like. Catalogue 18 provides inputs such as goods/commodities and services on sale along with the description and prices.

Supply database 20 aggregates, collects and maintains the supplier data information from distributed systems. Such data is processed for estimation and optimization computations and an optimum price of a commodity is generated. Once the optimum price is generated, it is provided to the retail platform where it is continuously monitored through monitoring module 26.

Monitoring module 26 is configured to access transaction data 14 in real time and further configured to compute actual top line and bottom line numbers achieved by a particular portfolio at various granular levels.

Pricing engine 12 receives multiple inputs from the sources described herein and determines an optimum price for a commodity. The manner in which the pricing engine is configured is described in further details below.

FIG. 2 is a block diagram of one embodiment of a pricing engine configured to generate an optimum price for plurality of commodities, according to the aspects of the present invention. The pricing engine 12 includes an insight module 32, a simulation optimizer 34, a price module 36 and a health check index module 38. Each block is described in further details below.

Insight module 32 is configured to enumerate a plurality of components that contribute to the pricing model. In an embodiment, such components are used to identify subset of one and more commodities with plurality of features. In addition, such components provide an insight at granular level which in turn will help to formulate strategies specifically targeting the intended audience with the intended feature at an optimum price. In one embodiment, such components are used to generate demand sensitivity and demand forecast for the subset of one or more commodities. In another embodiment, the demand forecast and the demand sensitivity are mutually exclusive.

In an embodiment, component metrics such as number of transactions, revenue contributions, gross margin contributions, trade discount spend contributions, list view contributions and return on investment are continuously computed. Various metrics may be used to create self-trends. Further, such trends are employed in estimation and analysis of the pricing model being used on the platform.

Simulation optimizer 34 is configured to generate a plurality of pricing models for each commodity in the subset. In an embodiment, the plurality of pricing models is generated by factoring a plurality of supply constraints of the subset plurality of commodities. In one embodiment, the optimization is performed to optimize the prices of multiple sets of highly related products/commodities within a product group. The optimization employs product cost figures to determine an optimum set of prices, and takes into consideration the effects in demand that price-changes in one set of highly related products will cause in all other sets of highly related products within the product group.

In an embodiment, each pricing model is computed based on a unique combination of price attributes by estimating statistical measures for the system and by known probability distributions. Each pricing model provides an observation of the system response by computing the statistics. Further in another embodiment, the simulation optimizer 34 is configured to receive feedback from the monitoring module 26.

Price module 36 is configured to select an optimum pricing model from the plurality of pricing models generated by the simulation optimizer. In an embodiment, the plurality of pricing models is ranked based on a return on investment index. In one embodiment, the price module 36 automatically selects the top ranked pricing model. In another embodiment, a suitable pricing model according to the requirement can be manually selected from the list of top ranked pricing models.

Health check index module 38 is configured to measure and assess the retail health to reflect the status of the business in terms of various attributes/factors. Such attributes include sales and profit among others. In an embodiment, the health check index module 38 is configured to monitor a performance of each commodity and to identify a plurality of non-performing commodities.

As described earlier, the insight module is configured to identify subset of one or more commodities with plurality of features to provide an insight at granular level to obtain an optimum price. The manner in which this is achieved is described below in further detail.

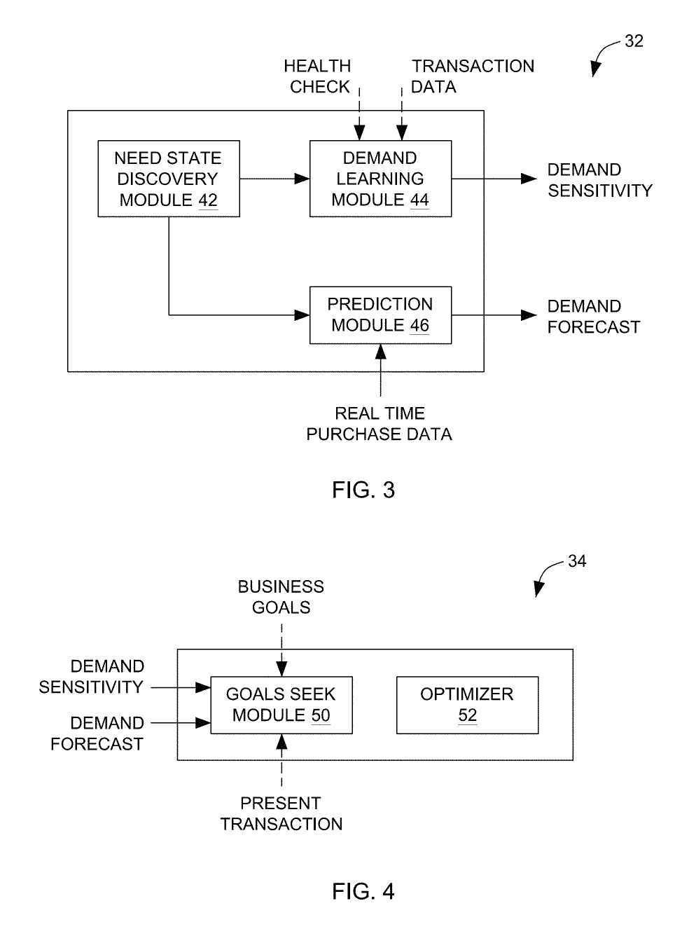

FIG. 3 is a block diagram of one embodiment of the pricing engine configured to enumerate a plurality of components that contribute to the pricing model, according to aspects of the present invention. The system 32 comprises of a need state discovery module 42, a demand learning module 44 and a prediction module 46.

Need state discovery module 42 is configured to identify a subset of the one and more commodities with a plurality of features. In one embodiment, the need state discovery module 42 is configured to segment the plurality of commodities into a plurality of collections and further derive a plurality of racks from the plurality of collections. Further, the plurality of racks is defined based on one or more commodity attributes and the plurality of collections is based on a browsing pattern and a purchase pattern. The need state discovery module 42 further interfaced with the demand learning module 44 and prediction module 46.

Demand learning module 44 configured to generate a demand sensitivity for the subset plurality of commodities. Demand sensitivity yields relative ranking of elasticities and helps understand demand as a function of varying factors. In one embodiment, the demand learning module 44 receives transaction data and health check index data to generate demand sensitivity.

Prediction module 46 which is configured to generate a demand forecast for the subset plurality of commodities. Prediction module 46 utilizes real time purchase data and data from need state discovery module 42 to generate a demand forecast.

As described earlier, the simulation optimizer is configured to generate a plurality of pricing models for each commodity in the subset. The manner in which it is achieved is described in further details below.

FIG. 4 is a block diagram of one embodiment of the pricing engine to generate a plurality of pricing models, according to the aspects of the present technique. The system 34 comprises of a goal seek module 50 and an optimizer 52.

Goal seek module 50 is configured to compile the available data and determine inputs required to reach specific goals. The results are used effectively in organizational and business decisions. In one embodiment, the goal seek module 50 receives raw data such as business goals, present transaction, demand sensitivity and demand forecast. The raw data is compiled into useful information that can be used to achieve specific goals. Goal seek module 50 thus facilitates the management of the portfolio as per business use case. In an embodiment, an expected cumulative goal for a point of time in a particular day may be set with respect to top line or bottom line goals. In an embodiment, based on the monitoring feedback, the system can seek towards specific revenue and gm targets.

Optimizer 52 is configured to generate a plurality of pricing models for each commodity by factoring a plurality of supply constraints of the subset plurality of commodities. In an embodiment, each pricing model is computed based on a unique combination of price attributes by estimating statistical measures for the system and by known probability distributions. In an embodiment, the optimizer 52 is configured to receive feedback. In one embodiment, the pricing models are indexed are ranked. The pricing model with the highest rank is then selected and applied to a product. The manner in which the optimum pricing model is selected is described below.

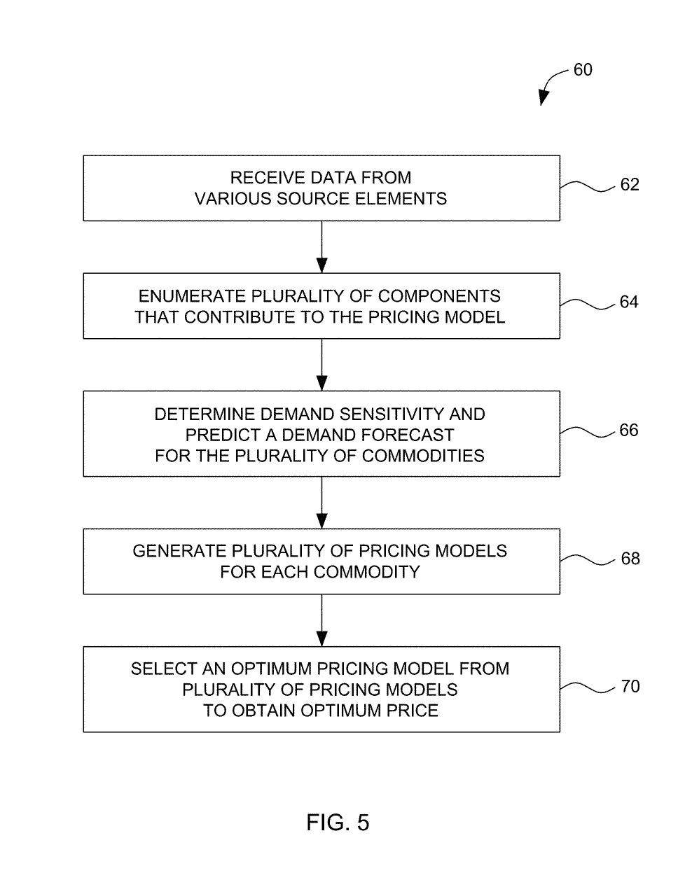

FIG. 5 is a flow diagram 60 illustrating the steps involved in generating the optimum price of one or more commodities, according to aspects of the present invention. The steps involved in achieving an optimum price of one or more commodities on a fashion retail are described in further detail below.

At step 62, the pricing engine receives data from various source elements such as user profile, transaction data, business inputs and catalogue of the products. Transaction data may include orders, invoices, payments, activity records, plans, deliveries, storage records and the like. Business inputs may include resources such as raw materials, energy, people, finance and the like. Catalogue provides inputs such as goods/commodities and services on sale along with the description and prices.

At step 64, the system enumerates the plurality of components that contribute to the pricing model. Further, such components are used to identify subset of one and more commodities with plurality of features.

At step 66, demand sensitivity is determined and demand forecast is predicted for the plurality of the commodities. This is achieved by providing an insight at granular level and formulating the strategies specifically targeting the intended audience with the intended feature at an optimum price. Demand sensitivity yields relative ranking of elasticities and helps understand demand as a function of varying factors.

At step 68, various pricing models are generated for each commodity in the subset. In an embodiment, the plurality of pricing models are generated by factoring a plurality of supply constraints of the subset plurality of commodities. In an embodiment, each pricing model is computed based on a unique combination of price attributes by estimating statistical measures and by known probability distributions.

At step 70, an optimum pricing model is selected from the plurality of pricing models. In an embodiment, the plurality of pricing models is ranked based on a return on investment index. The price module 36 by default selects the top ranked pricing model. In another embodiment, a suitable pricing model according to the requirement can be manually selected from the list of top ranked pricing models. The optimum pricing model generates an optimum price of one or more commodities in a fashion e retail. Thus, determining optimized prices for products or commodities within a product category, where the model considers the cost of the products as well as the demand for those products and other related products.

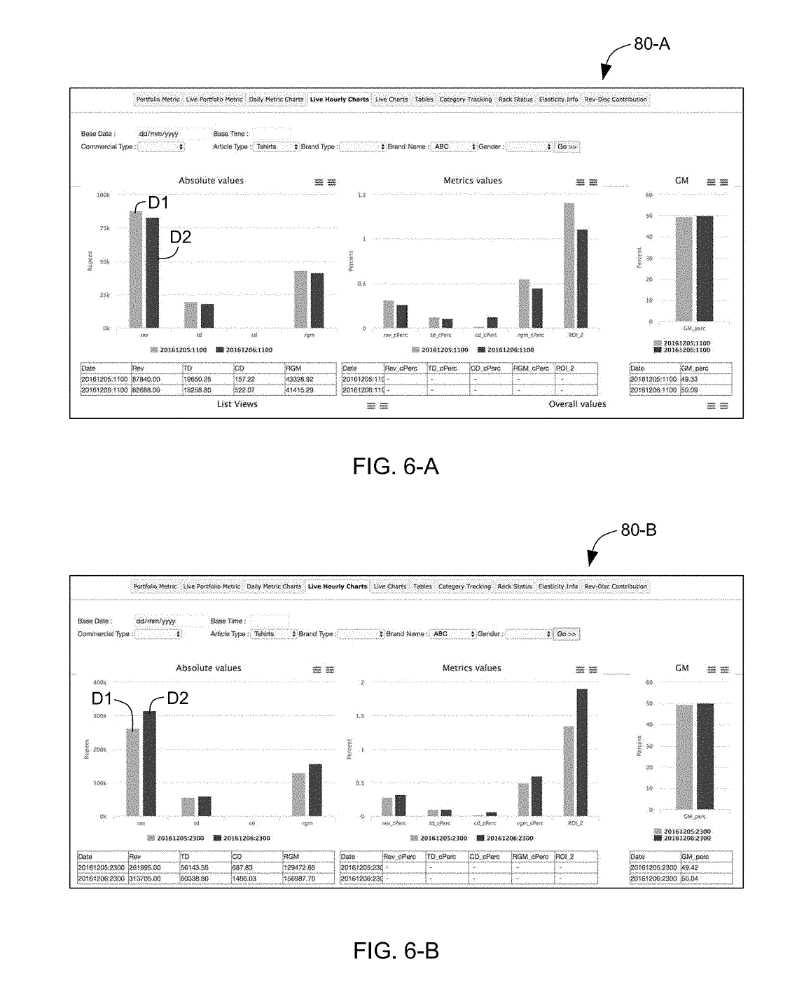

FIG. 6A and FIG. 6B are screenshots illustrating the comparison charts generated within the plurality of sub-categories, according to the aspects of the present invention. Metric charts 80-A and 80-B provide comparison between the desired values represented by D1 and the actual values represented generally by D2. In FIG. 6A, metric chart 80-A illustrates the actual values for different measurable parameters such as revenue (rev), trade discount (TD) and gross margin (RGM). As can be seen from chart 80-A, the actual values fall short of the desired values for a specific article (T-shirts, in this example).

FIG. 6B is a metric chart 80-B illustrating the values for the same article, but after an optimum price is generated using the techniques disclosed in the present invention. By taking in to account the different components that contribute to the pricing model, determining the demand sensitivity and predicting a corresponding demand forecast and selecting the optimum pricing model, the actual values represented generally by D2 have exceeded the desired values represented generally by D1.

It should be noted that multiple parameters are used to determine the optimal value. Examples of such parameters include price and sales history as a function of time (e.g., day of the week, season, holidays, etc.), promotion (e.g., temporary price reductions and other promotional vehicles), competition (e.g., price and sales history information for directly competitive products that are normally substitutes), product size variations, cost inputs and the like.

The system and method according to the above-described example embodiments of the inventive concept may be implemented with program instructions which may be executed by computer or processor and may be recorded in computer-readable media. The media may also include, alone or in combination with the program instructions, data files, data structures, and the like. The program instructions recorded in the media may be designed and configured especially for the example embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter. The described hardware devices may be configured to execute one or more software modules to perform the operations of the above-described example embodiments of the inventive concept, or vice versa.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A pricing system for generating an optimum pricing model for a plurality of commodities, the system comprising:
an insight module configured to enumerate a plurality of components that contribute to the pricing model; wherein the insight module comprises:
a need state discovery module configured to identify a subset of the one and more commodities a plurality of features;
a demand learning module configured to generate a demand sensitivity for the subset plurality of commodities;
a prediction module configured to generate a demand forecast for the subset plurality of commodities;
a simulation optimizer configured to generate a plurality of pricing models for each commodity in the subset; wherein each pricing model is computed based on a unique combination of price attributes; and
a price module configured to select an optimum pricing model from the plurality of pricing models.

2. The system of claim 1, wherein the need state discovery module is configured to segment the plurality of commodities into a plurality of collections and further derive a plurality of racks from the plurality of collections.

3. The system of claim 2, wherein the plurality of racks is defined based on one or more commodity attributes.

4. The system of claim 2, wherein the plurality of collections is based on a browsing pattern and a purchase pattern.

5. The system of claim 1, wherein the plurality of pricing models is ranked based on a return on investment index.

6. The system of claim 5, wherein the plurality of pricing models is generated by factoring a plurality of supply constraints of the subset plurality of commodities.

7. The system of claim 1, wherein the demand forecast and the demand sensitivity are mutually exclusive.

8. The system of claim 1, wherein the pricing models are formulated based on pre-defined business target.

9. The system of claim 1, further comprising a health-check index module configured to monitor a performance of each commodity.

10. The system of claim 9, wherein the health-check module is further configured to identify a plurality of non-performing commodities.

11. A method for generating an optimum pricing model for a plurality of commodities, the method comprising:
enumerating a plurality of components that contribute to the pricing model by:
identifying a subset of the one and more commodities a plurality of features;
generating a demand sensitivity for the subset plurality of commodities;
generating a demand forecast for the subset plurality of commodities;
generating a plurality of pricing models for each commodity in the subset;
wherein each pricing model is computed based on a unique combination of price attributes; and
selecting an optimum pricing model from the plurality of pricing models.

12. The method of claim 11, wherein the plurality of commodities is segmented into a plurality of collections and a plurality of racks is derived from the plurality of collections; wherein the plurality of racks is defined based on one or more commodity attributes.

13. The method of claim 11, wherein the plurality of pricing models is ranked based on a return on investment index and is generated by factoring a plurality of supply constraints of the subset plurality of commodities.

14. The method of claim 11, further comprising continuously monitoring a performance of each commodity.

15. The method of claim 14, further comprising identifying a plurality of non-performing commodities.
